(19) United States
(12) Patent Application Publication
(10) Pub. No.: US 2004/0126091 A1
(43) Pub. Date: Jul. 1, 2004

(54) Method and device for the recording and playback of contents

(76) Inventors: Ulrich Sieben, Voerstetteu (DE); Werner Sinnhoefer, Reute (DE)

Correspondence Address: Samuels, Gauthier & Stevens LLP, Suite 3300, 225 Franklin Street, Boston, MA, 02110, US

(21) Appl. No.: 10/652,737

(22) Filed: Aug. 29, 2003

(30) Foreign Application Priority Data
Aug. 29, 2002 (DE) 102 39 860.7

(51) Int. Cl. H04N 5/781; G11B 27/00

(52) U.S. Cl. 386/52; 386/125

(57) ABSTRACT

This invention relates to an apparatus and method for recording and playback of contents involving at least one receiving/storage unit and at least one storage/playback unit, with the at least one receiving/storage unit in each case recording contents, placing them in interim storage, managing them, and deleting them as appropriate in accordance with a first rule set assigned to it, and at least a part of the contents in each case being transferred to the at least one storage/playback unit in accordance with a second rule set and there stored, managed, and deleted as appropriate in accordance with the assigned second rule set. On the basis of the first and second rule sets, large quantities of contents can be recorded, stored, managed, and again deleted as appropriate in an optimized fashion for a user.

### BACKGROUND OF THE INVENTION

This invention relates to the field of playback devices, and in particular to a technique for the recording and playback of contents.

Devices are known for the recording television programs according to a preselection made by the user, using for example analog and digital video recorders. The selection of the programs to be recorded is made directly from a television program and programmed manually. The user does not need to be present in person for the recording, but must insert video cassettes at the proper time and manually note on which video cassette the transmission was recorded. In order to record radio programs, the user must be present at the proper time at the beginning of the transmission and must manually start and end the recording.

It is further known to assemble contents, chiefly music transmissions, on a computer and automatically load these contents onto a portable device, such as is marketed for example by the company Apple Inc. under the name I-Pod™. Such a portable device has a sufficiently large hard disk to store large quantities of audio transmissions and video transmissions or text files thereon. For example, some 1000 distinct pieces of music can be stored on a hard disk with a storage capacity of 5 GB.

It is already possible to manufacture hard disks with a capacity of 100 GB, and this capacity may be augmentable by several orders of magnitude in the foreseeable future. Storage media of this order of magnitude definitely can no longer be used in the customary way. For example, some thousands or tens of thousands of pieces of music cannot be manually recorded on a data medium and the data medium searched for a certain piece of music. Further, the question arises as to how filling the storage medium with unusable or unwanted information can be avoided or how information items that are no longer needed and are needlessly occupying storage space can be deleted from the storage medium again. It is impossible, for example, to search a plurality of thousands of pieces of music manually in order to determine whether titles no longer wanted by the user are present among them.

Therefore, there is a need for a technique of managing the recording and playback of contents stored on a large memory device.

### SUMMARY OF THE INVENTION

If a large storage medium is to be automatically filled with content, this can take place given a very large data offering in a rule-based fashion. It is no longer enough for the user to explicitly and manually label programs that are to be stored. For this reason, a technique for the recording and playback of contents employs at least one receiving/storage unit and at least one storage/playback unit, with the at least one receiving/storage unit recording contents, placing them in interim storage, managing them, and deleting them as appropriate according to a first rule set assigned to it, and with at least some of the contents in each case being transferred into the at least one storage/playback unit according to a second rule set and there being stored, managed, and deleted as appropriate according to the assigned second rule set. The place at which the two rule sets are stored is independent of the assignment of the rule sets, so that both rule sets can be stored on the receiving/storage unit or the first rule set on the receiving/storage unit and the second rule set on the storage/playback unit.

The at least one receiving/storage unit, using the first rule set as a filter, serves to effect local storage of contents worthy of recording from a large offering, while the storage/playback unit, using the second rule set as a further filter, can access the prepicked contents. The rules establish what kind of contents are to be recorded, so that manual selection of contents or even the user's presence at the proper time is not necessary for recording.

The contents are preferably recorded from broadcast programs, in particular from generally accessible radio and television programs. The broadcast programs transmitted daily, such as radio and television programs, offer a nearly inexhaustible quantity of contents from which contents are selected according to the first rule set and placed in interim storage on the receiving/storage unit. Here the receiving/storage unit can have access to all broadcast transmissions at any time. The first rule set contains information indicative of transmissions of which service are to be recorded at which time. In order to avoid overlaps, for example if a plurality of transmissions of interest to the user are carried at the same time, a plurality of parallel broadcast receivers may be used with the receiving/storage unit.

The at least one storage/playback unit can be separated from the at least one receiving/storage unit, the latter unit preferably being configured with respect to its dimensions such that it can be carried by the user without difficulty. The user can thus carry a selected quantity of contents along in mobile fashion, while the receiving/storage unit continues to record contents locally.

The first rule set may contain user-defined preferences with respect to desired contents to be recorded from the broadcast program. The first rule set is thus a filter individually defined by the user, with which only such contents of interest to the user are recorded from the broadcast program. The preferences are preferably accessible only on the associated receiving/storage unit and the associated storage/playback unit, so that user privacy is protected. For the same reason, information on the user's preferences should not be passed on, so that the user receives no unwanted advertising that might be directly tailored to him.

The contents of the at least one receiving/storage unit are preferably transferred to the at least one storage/playback unit automatically as soon as the at least one receiving/storage unit and the at least one storage/playback unit come into contact with one another. Naturally, a plurality of receiving/storage units and a plurality of storage/playback units can participate in the recording and playback of contents according to the present invention. The contents are transferred whenever arbitrary pairs of one receiving/storage unit and one storage/playback unit come into contact. In this way, the newly recorded contents stored in the receiving/storage unit are available on the storage/playback unit as quickly as possible. The contact between the at least one receiving/storage unit and the at least one storage/playback unit may be implemented for example via a cable link, a wireless link, or a data network connection.

A first rule set may be stored in each of the at least one receiving/storage units, and a second rule set is stored in each of the at least one storage/playback units. The first rule set controls the contact between the broadcast and the receiving/storage unit, while the second rule set governs the exchange between the receiving/storage unit and the storage/playback unit. Because a plurality of storage/playback units can communicate with one receiving/storage unit, and the several storage/playback units are usable by distinct users with a variety of preferences, the second rule sets may differ. In particular, they will be more special than the first rule set assigned to the receiving/storage unit, so that it is advantageous to assign a second rule set to each given user via the respective storage/playback unit. It may also be necessary on grounds of storage capacity that the second rule set is more special than the first rule set. Thus the receiving/storage unit can have available a larger storage and further resources as appropriate than the storage/playback unit, so that larger quantities of data can be stored in accordance with a more general first rule set. In particular, for local processing of the second rule set on the storage/playback unit, the second rule set is stored on the associated storage/playback unit. In this way the second rule set can be processed even when the portable is not connected to the intermediate.

The contents recorded from the broadcast program by the receiving/storage unit based upon the associated first rule set are preferably provided with certain additional information items. On the one hand, additional information makes easier retrieval of the recorded contents on the storage medium possible. On the other hand, it can also be displayed to the user in order to inform him of the contents. Additional information can be transmission-related data such as the date, time, and duration of the recording, name of the transmitter, and name of the broadcast.

Especially suitable as additional information, both for informing the user about the contents and for the organized filing and retrieval of the contents on the storage, are certain keywords that characterize the content of the recording. Especially advantageous as additional information are keywords related to the user's preferences that led to the recording of the contents. Additional information and/or keywords can also be taken from a source different from the broadcast transmission, for example from a description of the broadcast contents that can be acquired via a data network. Naturally, the full text of this description of the broadcast contents can also be linked as additional information with the recorded contents.

If there is no additional information, the broadcast content can be examined with a speech recognition program and keywords can be taken as additional information from the text obtained. The broadcast content is examined by a speech recognition program for predetermined keywords from a dictionary in which the keywords frequently employed by the user are collected. On the one hand, this method entails less effort than using a speech recognition program to transfer the full broadcast content to a text and likewise yields additional information items being predictive. On the other hand, having the broadcast content examined for keywords often employed by the user himself means that the content can be more easily classified by the receiving/storage unit and that the user can more quickly recognize whether the content is of interest to him.

The second rule set of the associated storage/playback unit can preferably be changed by the user. In this way, the user of the storage/playback unit can configure the contents that are transferred from a receiving/storage unit to his storage/playback unit according to his preferences. For example, upon a meeting with other users, he can immediately enter in his second rule set information items acquired about contents of interest.

In one embodiment, the at least one storage/playback unit using the associated second rule set, requests contents from the at least one receiving/storage unit. Thus the user of a storage/playback unit, via the second rule set, can actively decide what contents are to be loaded onto his storage/playback unit. Preferably, upon a contact (e.g., wireline or wireless) of the at least one receiving/storage unit and of the at least one storage/playback unit, the additional information items of the contents recorded in the receiving/storage unit can be searched for contents that are to be transferred to the storage/playback unit on the basis of the second rule set of the storage/playback unit. The search process takes place, for example, with the use of an index of the contents and their additional information items. Thus the user of the storage/playback unit acquires contents that correspond to his preferences.

The second rule set may react on the first rule set when the at least one receiving/storage unit and the at least one storage/playback unit come into contact. Changes in the second rule set are thus automatically received by the first rule set, so that the recording behavior of the receiving/storage unit is adapted to accord with the changed preferences of the user of the storage/playback unit.

The second rule set can preferably be automatically adapted to the user automatically through observation of user behavior. Thus there is an alternative to manual changing of the second rule set by the user. If the user especially often calls up contents that correspond to a certain preference, this preference acquires a higher priority. On the other hand, preferences of contents that are not recalled over a long time or that are immediately deleted by the user acquire a lower priority. If the second rule set of a storage/playback unit reacts on the first rule set when the storage/playback unit comes into contact with the receiving/storage unit, the receiving/storage unit can thus be instructed that contents corresponding to a preference with a now higher priority are to be recorded preferentially and, correspondingly, that contents corresponding to a preference with a now lower priority are to be selected from broadcast programs to a lesser extent. Solely by virtue of the user's preferentially listening to transmissions that correspond to his interests, such transmissions will also continue to be made available to him by the receiving/storage unit.

Contents can be exchanged between two storage/playback units when they come into contact. Thus the user of a storage/playback unit user is not limited to the contents of his own receiving/storage units. Instead, users with similar preferences can copy contents, which may differ in spite of similar preferences, from their storage/playback unit to the user's own storage/playback unit. When two storage/playback units come into contact, at least parts of their associated second rule sets may be exchanged between them. Thus it is possible, if a user is interested in the contents of a storage/playback unit of another user, to seek similar contents with the user's own receiving/storage unit in the future after the user's changed second rule set has been returned to the receiving/storage unit and to the associated first rule set.

Preferably the at least one receiving/storage unit automatically converts the recorded contents to a format compatible with the at least one storage/playback unit. Thus a conversion program must be installed on the receiving/storage unit, and not on the possibly numerous storage/playback units. This reduces costs and facilitates a rapid changeover if there is a change in the format required by storage/playback units.

The at least one receiving/storage unit accesses, via a digital or analog wired or wireless interface, an apparatus that in turn accesses the broadcast programs. In this way it is possible, for example, that even pieces of music or talks coming from loudspeakers can be recorded on a receiving/storage unit.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 shows access possibilities between broadcast sources, a receiving/storage unit, and two storage/playback units,

FIG. 2 shows various information items that may be taken into account in a first and second rule set, and

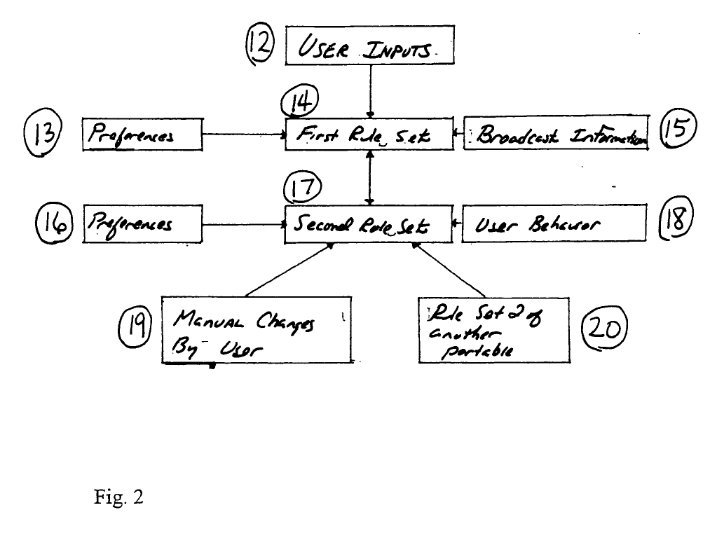

FIG. 3 shows an example of a tree diagram of a user's preferences.

### DETAILED DESCRIPTION OF THE INVENTION

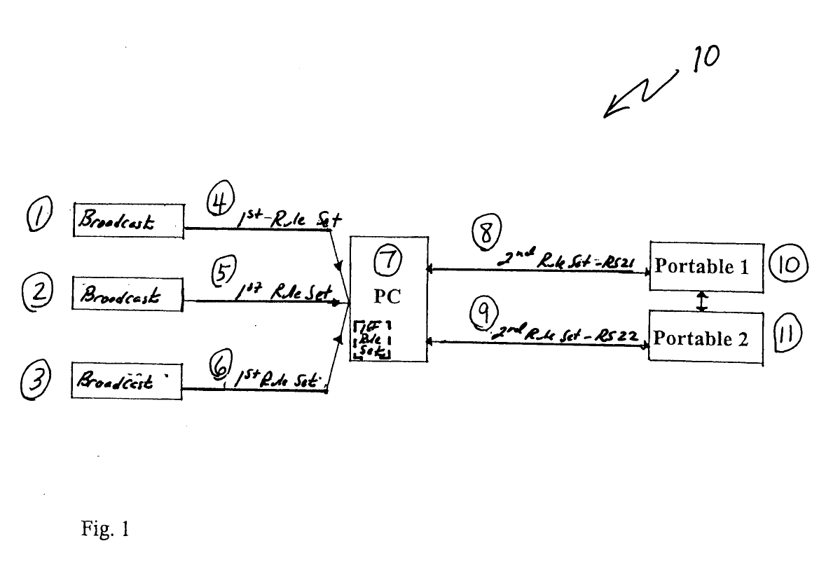

FIG. 1 is a functional block diagram illustration of a recording and playback system 10. The system 10 includes a receiving/storage unit 7 designed, for example, as a computer. The computer 7 is linked to a plurality of broadcast receivers 1-3 via for example a USB bus. Following a first rule set, the computer records 7 transmissions from the broadcast program via the three broadcast receivers 1-3. Two portable storage/playback units 10-11 (for example MP3 players) but more generally referred to below as portables, each communicating with the computer via a second rule set, can be hooked up to the computer.

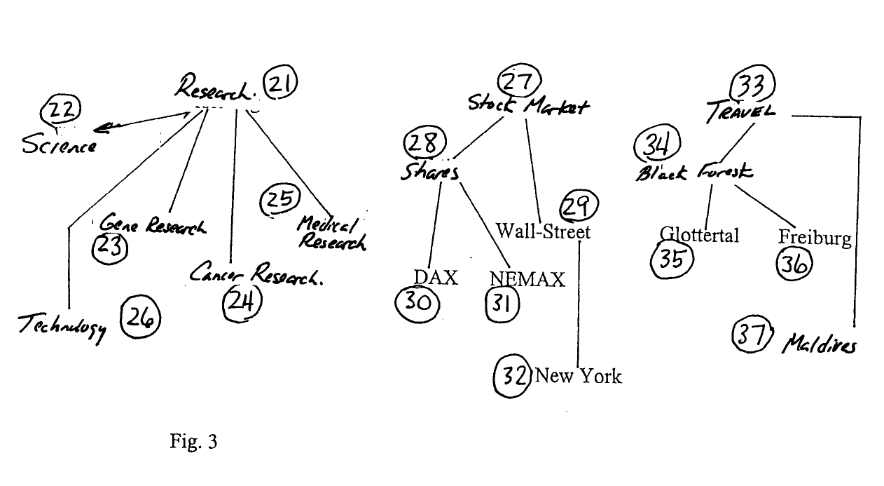

The recording of transmissions of a radio program takes place as follows. First, the preferences of a user are ascertained. The user's preferences in the present example lie in the area of “research,” “stock market” and “travel,” in particular “Black Forest”, as shown in FIG. 3. On the basis of these preferences and suitable synonyms as appropriate, a tree diagram of the preferences is created, in which preference terms are ordered by their priority. The given preferences “research,” “stock market” and “Black Forest” have very high priority. Synonyms such as “science” are also accorded high priority. Terms that can only be remotely assigned to the several areas, such as for example the free-standing term “New York” in the “stock market” area, are accorded lower priority.

The computer (FIG. 1) has access to a complete broadcast program and a list of broadcast services with associated frequencies. On the basis of preference information items, the items of broadcast information (e.g., the radio program and possibly also descriptions of individual transmissions existing in a data network) are examined in order to determine which of the transmissions fall within the user's preferences. A list is created showing what transmissions are to be recorded, from which service and at what time. If a plurality of transmissions overlap, a plurality of broadcast receivers can be employed for recording as shown in FIG. 1. If the number of overlapping transmissions is greater than the number of broadcast receivers hooked up to the computer, either the user can manually resolve the conflict if it has been brought to his attention by the system, or the computer 7 refers to preference information and records the higher-priority transmissions.

A timer controls when a transmission is up for recording. The computer 7 selects at the proper time one of the broadcast receivers 1-3, sets it to the correct frequency and starts recording. The broadcast signal is digitized and compressed as appropriate, and then the data are stored in the computer's storage 102. At the same time, an entry is generated in a list of transmissions recorded preferably stored in the computer 7, which the user can access.

The recorded broadcast transmissions are provided with additional information by the computer. Additional information can be made up first of transmission-related data, for example the date, time and duration of the transmission, name of service, and name of transmission. Further, the preference information terms that led to the recording can be appended. For example, a transmission may have been selected on the basis of the term “Freiburg,” so that this term is to be presented in the additional information in order to distinguish this transmission from transmissions with the additional information “Glottertal.” Further, the data network description of the broadcast contents can be taken over in whole or in part as additional information. The additional information can also be taken from a broadcast data service such as for example RDS [Radio Data System].

If, for undetermined reasons, there should be no such additional information, it is possible to analyze the recorded transmission with a speech recognition program. Terms occurring especially frequently in the text thus acquired can then be chosen as additional information. Because complete analysis of the text with a speech recognition program is very expensive and often inaccurate, the speech recognition program can also be used merely to check the broadcast content for certain terms. These terms can for example be keywords frequently employed by the user or preferences that are collected in a dictionary. A large quantity of recorded transmissions with appended additional information is now available on the computer.

If it is known that, for example, transmissions at a certain time of day may be of interest according to the preference list, it is possible to investigate just such radio or television transmissions for the frequency of occurrence of keywords from the preference list and, if appropriate, to store them retroactively.

The user can now hook up his portable to the computer. A second rule set is stored on the portable, containing among others the preference information item “research.” When the portable is hooked up, additional information of the transmissions stored on the computer is thus automatically searched for the term “research” and terms linked with this term. These transmissions are automatically transferred from the computer to the portable. The first rule set may also include the stored instruction that these recalled transmissions are to be deleted from the computer if no further users are interested in this transmission. Thus only up-to-date transmissions are present on the computer storage and the storage medium is not burdened with superfluous transmissions. The user can now disconnect his portable and use it in mobile fashion.

Transmissions to which the user of the portable has already listened can be deleted immediately by the user. Transmissions that did not appeal to the user can be entered by him in the second rule set. If the user was especially pleased with a transmission, he can enter in the second rule set that this transmission is to be recorded with high priority in the future and similar transmissions are to be selected from the broadcast program. In addition to the manual changes in the second rule set by the user, the user is “observed” by the second rule set. If a certain transmission is not listened to by the user immediately or not at all within a certain span of time, the associated preference information is provided with a lower priority by the second rule set. If, on the other hand, a certain transmission is listened to more than once, the priority of the corresponding preference information rises. Transmissions that are immediately deleted by the user without being listened to are also noted. Furthermore, the second rule set can automatically delete transmissions that are not recalled by the user even after a longer time, in order to free up storage space for transmissions of greater interest.

If the user of a portable meets a second user, the two portables can be put in contact (e.g., via a wireline or wireless connection) with one another. By means of the second rule set, contents of interest to the user of the first portable can also be copied to the portable from the second portable. Instead of specific transmissions, parts of preference lists or of second rule sets can also be exchanged between the portables. Thus the user of the first portable is enabled in the future, after his portable next comes into contact with his computer, to cause transmissions of interest to him that he would not have acquired with his own second rule set to be recorded. What is more, contents that are taken over into a portable from another portable can also be copied to the intermediate in order in this way to make the contents available to the other users of the intermediate. This copying of data from the portable to the intermediate preferably takes place in a rule-based manner. Thus, for example, preferences of other users who access this intermediate can be known to the portable, so that only information items of interest to the other users, which can later be recalled by these other users, are carried.

The data conveyed from the portable back to the intermediate can be employed in the intermediate in order to change the first rule set so that contents are received and stored according to changed preferences in the future.

For communication between two portables, a third rule set, which specifies what data are to be exchanged with the portable of another user, can also be implemented in each of the portables.

The second rule set further makes it possible to hook up the portable even to an unknown computer and search the latter for contents and transmissions of interest to the user. Further transmissions of possible interest can be found in this way that were not found with the user's own first rule set. It is possible to transfer parts of this first rule set to the user's own portable, change the user's own second rule set with them, and have this react on the user's own first rule set.

If now the user again hooks up his portable to his computer, he first acquires the newly stored transmissions from the broadcast program. Furthermore, the second rule set hands on his changes to the first rule set. The changed priorities of preference information items or new preference terms lead to other transmissions being recorded from the broadcast program afterward. In addition, the first rule set can also be directly changed by the user on the computer. It is further possible also to change the second rule set on the computer, because this is more easily possible with the existing computer keyboard than on the portable itself. Communication of the two rule sets, manual changing of the rule sets by the user, and “observation of user behavior” make possible optimized recording of transmissions of interest to the user from the broadcast program.

If a plurality of portables access one computer, the computer must take account of all information items of the various second rule sets in the first rule set so that the transmissions of interest to each user are recorded for that user. Furthermore, the first rule set must contain informationas to which portable has already recalled a transmission and for which further portable this transmission is still of interest. No transmission for which a demand from one single portable still exists may be deleted, even if this transmission is no longer of interest to other portables. If there are not enough resources for the recording of a plurality of transmissions at the same time, the first rule set must furthermore include a prioritization of the various portables and their users. In this prioritization, in turn, the various preference information items can also be assigned weights. If, furthermore, a “foreign portable” is hooked up to the computer, this fact must likewise be recognized so that its second rule set does not change the computer's first rule set, a change that could result in transmissions of interest to the proper users no longer being recorded. Thus, optimization with respect to the transmissions recorded is sought through a multitude of effects on the first and second rule set and the interaction of the first and second rule sets.

Although the present invention has been shown and described with respect to several preferred embodiments thereof, various changes, omissions and additions to the form and detail thereof, may be made therein, without departing from the spirit and scope of the invention.

What is claimed is:

1. A method for recording and playback of contents involving at least one receiving/storage unit and at least one storage/playback unit, comprising the at least one receiving/storage unit recording contents, placing them in interim storage, managing them, and deleting them as appropriate according to a first rule set assigned to it, and at least part of the contents in each case being transferred into the at least one storage/playback unit according to a second rule set and there being stored, managed, and deleted as appropriate according to the assigned second rule set.

2. The method according to claim 1, wherein the contents are recorded from broadcast programs, in particular from generally accessible radio and television programs.

3. The method according to claim 2, wherein the at least one storage/playback unit can be disconnected from the at least one receiving/storage unit.

4. The method according to claim 1, wherein the first rule sets contain user-defined preferences with respect to desired contents to be recorded from the broadcast program.

5. The method according to claim 4, wherein the preferences are accessible only on the associated receiving/storage unit and the associated storage/playback unit.

6. The method according to claim 3, wherein the newly recorded contents are transferred from the at least one receiving/storage unit to the at least one storage/playback unit as soon as the at least one receiving/storage unit and the at least one storage/playback unit come into contact.

7. The method according to claim 6, wherein the contact between the at least one receiving/storage unit and the at least one storage/playback unit is implemented via a cable link or a wireless link, in particular via a telephone network link, or a data network connection.

8. The method according to claim 7, wherein a first rule set is stored in each of the at least one receiving/storage unit and a second rule set is stored in each of the at least one storage/playback unit.

9. The method according to claim 8, wherein the contents to be recorded from the broadcast program by the at least one receiving/storage unit are provided with certain additional information items on the basis of the associated first rule set.

10. The method according to claim 9, wherein certain keywords related to the user's preferences are contained in the additional information.

11. The method according to claim 10, wherein the additional information is processed before being forwarded, so that only additional information that is significant to the user of the portable is accessible/used for searching.

12. The method according to claim 11, wherein the additional information and/or the keywords are taken from a data service of the broadcast program or a data source independent of the broadcast program.

13. The method according to claim 9, wherein the broadcast content is examined by a speech recognition program and keywords are taken as additional information from the text obtained.

14. The method according to claim 9, wherein the broadcast content is examined by a speech recognition program for certain keywords in a dictionary in which the keywords frequently employed by the user are collected and the keywords detected by the speech recognition program are employed as additional information.

15. The method according to claim 14, wherein the additional information items are stored in the receiving/storage unit as dictated by the first rule set and forwarded to the storage/playback unit as dictated by the second rule set.

16. The method according to claim 1, wherein the second rule set of the associated storage/playback unit can be changed locally.

17. The method according to claim 1, wherein the at least one storage/playback unit, using the associated second rule set, requests contents from the at least one receiving/storage unit.

18. The method according to claim 1, wherein when the at least one receiving/storage unit and the at least one storage/playback unit come into contact, the additional information items of the contents recorded in the receiving/storage unit are searched, on the basis of the second rule set of the storage/playback unit, for contents that are to be transferred into the storage/playback unit.

19. The method according to claim 18, wherein the second rule set reacts on the first rule set when the at least one receiving/storage unit and the at least one storage/playback unit come into contact.

20. The method according to claim 1, wherein the second rule set is automatically adapted through observation of user behavior.

21. The method according to claim 1, wherein when two storage/playback units come into contact, contents are exchanged between them.

22. The method according to claim 1, wherein when two storage/playback units come into contact, at least parts of their associated second rule sets are exchanged between them.

23. The method according to claim 1, wherein the at least one receiving/storage unit automatically converts the recorded contents to a format compatible with the at least one storage/playback unit or also retains them multiply.

24. The method according to claim 23, wherein the receiving/storage unit retains the recorded contents in various formats.

25. The method according to claim 1, wherein the at least one receiving/storage unit accesses, via a digital or analog wired or wireless interface, an apparatus that in turn accesses the broadcast program.

26. The method according to claim 1, wherein characterized in that the storage/playback unit delivers contents to the receiving/storage unit when in contact with the receiving/storage unit.

27. The method according to claim 26, wherein the contents change the first rule set.

28. An apparatus for the recording and playback of contents, comprising at least one receiving/storage unit and at least one storage/playback unit, having in each case a first rule set assigned to the receiving/storage unit to control the recording, storage, management, and deletion as appropriate of contents in the at least one receiving/storage unit and having in each case a second rule set assigned to the storage/playback unit for the transfer of at least a part of the contents from the at least one receiving/storage unit to the at least one storage/playback unit and for storage, management and deletion as appropriate on the at least one storage/playback unit.

29. Device according to claim 28, wherein the at least one receiving/storage unit is a computer.

30. Device according to claim 29, wherein at least one of the at least one storage/playback units uses a standard of the MPEG Consortium.
